(19) United States
(12) Patent Application Publication
(10) Pub. No.: US 2017/0241908 A1
(43) Pub. Date: Aug. 24, 2017

(54) Apparatus for Digital Infrared Detection and Methods of Use Thereof

(71) Applicant: Gilbert D. Feke, Windham, NH (US)

(72) Inventor: Gilbert D. Feke, Windham, NH (US)

(21) Appl. No.: 15/047,677

(22) Filed: Feb. 19, 2016

(51) Int. Cl. G01N 21/64; G01J 1/04; G01J 1/44

(52) U.S. Cl. CPC G01N 21/64; G01J 1/44; G01J 1/0488; G01J 1/0407; G01J 2001/448; G01N 2021/6419

(57) ABSTRACT

An apparatus has a transducer with a storage phosphor that is chargeable to emit light of a first wavelength in response to an excitation light of a second wavelength from an object scene, wherein the second wavelength is longer than the first wavelength. A digital light sensor is disposed to accumulate energy from the emitted light of the transducer and to generate a signal according to the accumulated energy. A charging illumination source is configured to direct a pulsed charging illumination of a third wavelength, shorter than the first wavelength, to the storage phosphor. A control logic processor is in signal communication with the digital light sensor and the charging illumination source and controls synchronization of the timing of pulsed charging illumination and energy acquisition and readout of the digital light sensor.

### FIELD OF THE INVENTION

This disclosure relates generally to infrared sensing and more particularly to apparatus and methods for conditioning and sensing infrared excitation of an optically-charged phosphor layer.

### BACKGROUND OF THE INVENTION

Infrared (IR) light detection is known in the art with numerous applications including medical, reconnaissance, geographical surveys, resource management (including roads, buildings, and utilities), law enforcement, environmental and agricultural assessment, art authenticity analysis, forgery investigation, beam analysis, astronomy, and pictorial applications.

The visible light spectrum is commonly defined with a wavelength band that ranges from 0.4 to 0.7 μm (400 to 700 nm), corresponding to the approximate response of the human eye. The infrared light spectrum, on the other hand, is commonly subdivided into bands corresponding to the response of different detector technologies. The near-infrared (NIR) band is commonly defined to range from 0.7 to 1.0 μm, corresponding to the range from the approximate limits of response of the human eye to the approximate limits of the response of silicon detectors. The short-wavelength infrared (SWIR) band is commonly defined to range from approximately 1.0 to 3 μm; indium gallium arsenide (InGaAs), germanium (Ge), and various lead salt detectors are sensitive in this SWIR range. The mid-wavelength infrared (MWIR) band is commonly defined by the atmospheric window from about 3 to 5 μm; indium antimonide (InSb), mercury cadmium telluride (HgCdTe), and lead selenide (PbSe) detectors are sensitive over the MWIR range. The long-wavelength infrared (LWIR) band is commonly defined by the atmospheric window from about 7 to 14 μm; HgCdTe is sensitive in the LWIR range. Finally, very-long wave infrared (VLWIR) is commonly defined to range from approximately 12 to about 30 μm; doped silicon detectors are sensitive in the VLWIR range.

The aforementioned detector technologies are all examples of direct photodetection in which absorption of incident infrared light causes a corresponding change in some device parameter (e.g., conductivity, charge capacitance, voltage, temperature, etc.), and can also affect translation of the changed parameter into some measurable value (e.g., voltage, current, etc.). Digital light sensors based on direct photodetection of infrared light, however, are typically subject to significant constraints. Limitations of conventional digital IR sensors including relatively small active area, low pixel resolution, high noise or requirements for deep cooling for noise minimization, high cost, and relative difficulty of miniaturization and integration.

Various methods of indirect photodetection of infrared light have been developed that overcome many of the limitations of direct photodetection. Imaging devices based on indirect photodetection of infrared light typically combine a visible light sensor with a transducer. The light sensor that is typically used for indirect photodetection of IR light can be a digital light sensor, such as a charge-coupled device (CCD) sensor or a complementary metal-oxide-semiconductor (CMOS) sensor. These types of photosensor are typically silicon-based, with sensitivity range typically limited to visible and NIR light, at wavelengths shorter than 1064 nm. The photosensor operates on the principle of generation and readout of photocharge in response to light. The transducer for indirect photodetection is configured to generate visible or NIR light for detection by the digital light sensor in response to light having wavelengths beyond NIR wavelengths. Thus, for example, a transducer emits visible or NIR light when it receives light having longer than NIR wavelengths (longer than about 1064 nm). A transducer known in the art is a phosphor layer that is typically coated onto a plate or screen that is imageable by, or optically coupled to, the digital light sensor. The phosphor layer can optionally be coated directly over the digital light sensor.

Generally, two different types of phosphors are known in the art for transducing infrared light beyond the NIR into visible or NIR light: up-converting phosphors and optically-chargeable or storage phosphors.

An upconverting phosphor relies on an anti-Stokes process. For example, in U.S. Pat. No. 6,943,425 to Costello there is described a back thinned digital light sensor in which an upconverting anti-Stokes phosphor is added on the front surface to extend the wavelength range of the sensor. Also, in U.S. Pat. No. 7,075,576 to Creasey et al. there is described a CCD sensor having an upconverting anti-Stokes phosphor layer bound thereto. Also, in U.S. Pat. Appl. Pub. No. 2006/0186363 of Hazelwood and Weatherup there is described a digital light sensor having an enhanced spectral range and using an upconverting anti-Stokes phosphor.

The term “anti-Stokes” refers to emission behavior of a material which does not conform to Stokes' second law. Stokes second law posits that fluorescence emission is lower in photon energy than the absorbed photon energy for a material. Upconverting anti-Stokes phosphors are capable of emitting photons having higher energy than the photons they absorb because they rely on multi-photon absorption to achieve the energy balance.

Many instances of anti-Stokes emission have been observed in different material systems, but perhaps the most efficient of these are from pairs of non-identical triply-ionized rare-earth ions, for example, Er³⁺, Yb³⁺ doped into a crystalline host. A characteristic of upconverting phosphors is their nonlinear response to incident illumination. For example, the emission intensity of upconverting phosphors relying on two-photon absorption is proportional to the square of the incident light intensity. Although it has the effect of emphasizing brighter features of the incident radiation, such a nonlinear response is often undesirable relative to the desired sensitivity and quantification. The sensitivity of typical upconverting phosphors is often unacceptably low when the incident intensity is relatively low. Although sensitivity characteristics can be improved to a certain extent by relying on relatively thicker phosphor coating, this can have the effect of limiting the resolution of indirect photodetection due to increased light scattering through the thicker coating. Also, the spectral range of upconverting phosphors for infrared detection is typically narrow. Furthermore, the non-proportional response of the nonlinear process distorts the spatial characteristic of detected infrared features and therefore requires image post-processing correction.

Optically-chargeable phosphor, also termed storage phosphor, used for transducing infrared light beyond the NIR region into visible or NIR light, relies on an electron trapping process. Optically-chargeable phosphors rely on prior absorption of a visible or ultraviolet (UV) photon to excite the phosphor molecules into a metastable state of relatively long duration, employing so-called electron trapping. With the material in this state, an incident infrared photon that is subsequently absorbed by the phosphor, from a wavelength source beyond the NIR, triggers the energy release with a visible or NIR luminescence that signifies the incident infrared light. For example, in U.S. Pat. No. 2,482,815 to Urbach there is described an infrared photography method using optically-chargeable phosphor material and contact or projection printing with photosensitive material such as a photographic emulsion. Also, in U.S. Pat. No. 5,065,023 to Lindmayer there is described an infrared photography and imaging system and method using electron trapping materials and a CCD sensor. Also, in U.S. Pat. Appl. Pub. No. 2006/0186363 by Hazelwood et al. there is described an enhanced spectral range digital light sensor that includes embodiments comprising an optically-chargeable phosphor.

The fundamentals of electron trapping material are the following: A host crystal is a wide bandgap semiconductor (II-VI compound), normally without any special value. These crystals, however, can be doped heavily with impurities to produce new energy levels and bands. Impurities from the lanthanide (rare earth) series are readily accommodated into the lattice and form a “communication” band and a trapping level. The communication band replaces the original conduction band and provides an energy level at which the electrons may interact. At lower energies, the trapping level represents non-communicating sites. Materials that contain sites where luminescent activity occurs often include one or more types of these sites where electrons may be trapped in an energized state.

Upon application of suitable wavelengths of energizing radiation such as visible or ultraviolet light, such treated sites produce free energized electrons. The free electrons are raised to an energized state within a communication band where transitions such as absorption and recombination may take place. Upon removal of the energizing radiation, the free electrons may be trapped at an energy level higher than their original ground state or may drop back to their original ground state. The number of electrons that become trapped is very much dependent upon the composition of the phosphor material and the dopants used therein. If the trapping level is sufficiently below the level of the communication band, the electron is isolated from other electrons and remains trapped for a long period of time, unaffected by normal ambient temperature. Indeed, if the depth of the trap is sufficient, the electron remains trapped almost indefinitely, unless the electron is energized by energy from light such as infrared light, from other electromagnetic energy, or from thermal energy at levels much higher than room temperature. The electron remains trapped until light or other radiation is applied to provide sufficient energy to the electron to again raise its energized state to the communication band where a transition may take place in the form of recombination, allowing the electron to escape from the trap and release a photon of visible light. The material must be such that thermal energy at ambient temperature is insufficient to allow any significant portion of trapped electrons to escape from their traps.

Examples of optically-chargeable phosphor material known in the art include alkaline earth metal sulfide or selenide bases doped with rare earth impurities. For example, in U.S. Pat. No. 4,839,092 to Lindmayer there is described a material formed of a strontium sulfide base doped with samarium and europium (SrS:Sm,Eu) that emits visible light at about 620 nm upon infrared irradiation after optical charging. Similarly, in U.S. Pat. No. 4,842,960 to Lindmayer there is described a material formed of a mixed strontium sulfide/calcium sulfide base doped with samarium and europium (SrS/CaS:Sm,Eu) that emits visible light at about 630 nm upon infrared irradiation after optical charging. Also, in U.S. Pat. No. 4,879,186 to Lindmayer there is describe a material formed of a calcium sulfide base doped with samarium and europium (CaS:Sm,Eu), that emits visible light at 660 nm upon infrared irradiation after optical charging. Also, in U.S. Pat. No. 4,822,520 to Lindmayer there is described a material formed of a strontium sulfide base doped with samarium and cerium (SrS:Sm,Ce) that emits visible light at about 495 nm upon infrared irradiation after optical charging. Also, in U.S. Pat. No. 4,812,660 to Lindmayer there is described a material formed of a calcium sulfide base doped with samarium and cerium (CaS:Sm,Ce) that emits visible light at about 510 nm upon infrared irradiation after optical charging.

The optically-chargeable phosphors typically used for indirect photodetection of infrared light are advantageous in that they exhibit a relatively wide and continuous wavelength range, as well as high sensitivity in response to incident infrared illumination. A disadvantage of optically-chargeable phosphors relates to discharge rate. The excited electrons can become depleted by the luminescence process in as little as a few seconds depending upon the intensity of the incident illumination. If no countermeasures are taken, the discharging may result in inadequate emission intensity, can manifest as a non-proportional response that distorts the spatial characteristic of detected infrared features, and can eventually render the phosphor transducer to be unresponsive to incident excitation. Therefore sustained use of an optically-chargeable phosphor layer for quantitative, or undistorted, infrared detection, or infrared detection over long periods of time, requires countermeasures against discharging.

One countermeasure known in the art involves compensating for inadequate emission intensity due to discharging by simply increasing the thickness of the phosphor layer. A thicker phosphor layer yields more phosphor material per unit area and therefore, to a certain extent, greater efficiency of infrared detection. However, spatial resolution of infrared detection is undesirably degraded as the thickness of the phosphor layer increases due to scattering within the phosphor layer. Furthermore, simply increasing the bulk phosphor content fails to remedy the effects of discharging just described, such as the non-proportional response and the ultimate depletion of the phosphor.

Another countermeasure known in the art involves compensating for inadequate emission intensity due to discharging by simply increasing the dose of the optical charging illumination. Greater dosage of optical charging illumination yields, to a certain extent, more free energized electrons available for traps and hence recombination upon stimulation by infrared light. However, because the dose of the optical charging illumination is a function of both intensity and time, this strategy may impose undesirable limitations on the optical charging illumination source with regard to size, power requirements, expense, and speed. Furthermore, the undesirable effects of discharging such as the non-proportional response and the ultimate depletion of the phosphor are not remedied.

Yet another countermeasure known in the art involves physically moving the phosphor layer, such as by rapid translation or rotation. This method simply interposes newly charged material into the sensor and infrared illumination path. This strategy is often invoked for visualizing small beams over short intervals, but becomes less feasible and less useful for relatively larger detection areas and relatively longer detection intervals because the physical area of the phosphor-coated plate or screen must be sufficiently large to provide enough optically-charged zones during the detection event. Increased surface area and bulk introduces more problems with respect to space limitations, convenience, manufacturability, uniformity, and expense. Also, if the motion of the phosphor-coated plate or screen is not sufficiently fast then infrared detection may extend over partially discharged areas resulting in distortions. Uniformity correction to compensate for spatial variation of phosphor response is also complicated by moving the phosphor-coated plate or screen. Furthermore, because this strategy involves moving the phosphor-coated plate or screen, it is not applicable to a stationary layer or to a phosphor layer coated directly over a digital light sensor.

Yet another countermeasure known in the art involves recharging the phosphor layer. In one strategy known in the art the phosphor layer, typically coated onto a plate or screen which is by necessity detached from the digital light sensor, is removed from the detection path for recharging and then subsequently reinserted to resume detection. For example, in U.S. Pat. No. 6,259,103 to Pressnall there is described a detector for an infrared laser beam involving a chopper wheel having phosphor-coated layers affixed to spokes that are periodically rotated for recharging. Although this strategy minimizes the physical area of the phosphor-coated plate or screen required for detection, it is problematic for relatively long, continuous detection events, such as video capture or long image capture integrations. With such a method, the recharging operation, whose speed is limited by mechanical constraints, can cause relatively long interruptions in the detection event. Also, uniformity correction to compensate for spatial variation of phosphor response is limited by the positioning accuracy of the reinsertion of the phosphor-coated plate or screen into the detection path. Furthermore, because this strategy involves moving the phosphor-coated plate or screen, it is not applicable to a phosphor layer coated directly over a digital light sensor.

Yet two other recharging strategies are described in U.S. Pat. Appl. Pub. No. 2006/0186363 that do not require physically moving the phosphor layer and are therefore suitable for an optically-chargeable phosphor layer that is coated directly over a digital light sensor as well as onto a detached plate or screen. One of these strategies is applicable only for video capture. This approach involves the optical charging illumination pulsing in phase with, or during, one video frame among a repeating series of video frames of the digital light sensor, for example one out of every five frames. Although the charging illumination itself is superimposed with the emitted light from the phosphor layer for the one video frame, the affected frame is discarded from the output image stream. Because the phosphor response changes with a decay rate dependent upon the illumination from the scene viewed by the digital light sensor, the stability of the video image would therefore be scene dependent and undesirably appear to flicker at the charging rate in addition to the periodic absence of the discarded frame. A further problem relates to afterglow from the phosphor layer. Intrinsic phosphorescence or autofluorescence simulated by the optical charging illumination alone, and not due to incident infrared illumination, could add unwanted background to the detected signal. Such unwanted background could be time-dependent and decay during each series of video frames thereby itself appearing to flicker at the charging rate.

The other of the two strategies described in U.S. Pat. Appl. Pub. No. 2006/0186363 is applicable for both single image capture integrations as well as video capture and involves constant charging illumination, and hence continuous recharging, of the optically-chargeable phosphor layer during imaging. This strategy requires an optical blocking filter between the phosphor layer and the digital light sensor. This blocking filter helps to prevent the optical charging illumination, which by necessity must be spectrally distinct from the emission light from the phosphor, that is transmitted, reflected, or scattered towards the digital light sensor, from being detectable by the sensor. This strategy is subject to certain limitations, however. For example, in addition to charging the phosphor layer, the optical charging illumination may also excite some amount of unwanted fluorescence from the phosphor layer or from other components in the detection path. For example, various components such as lenses and painted or anodized surfaces may have an emission wavelength range that overlaps with the emission wavelength range of the phosphor layer itself. This would contribute an undesirable background signal to the images that may be especially problematic for low-light infrared detection. Also, in cases where it is desired to use the digital light sensor for both infrared and visible or ultraviolet detection with a removable phosphor layer, the optical blocking filter may also need to be removable if it is desired to image light within the filter's blocking range. Furthermore, afterglow from the phosphor layer, for example intrinsic phosphorescence or autofluorescence simulated by the optical charging illumination alone, and not due to incident infrared illumination, could add unwanted background to the detected signal. Furthermore still, in cases where the phosphor layer is directly coated over the sensor, the physical thickness of the optical blocking filter causes a physical separation between the phosphor layer and the digital light sensor that has the effect of degrading the spatial resolution of detection due to divergence of the emission from the phosphor layer.

Thus, there remains a need for an effective countermeasure against discharging of optically-chargeable phosphors in infrared detection applications, especially in those applications requiring relatively long or continuous detection events, high sensitivity, high spatial resolution, quantitative results, or minimal requirements for the optical charging illumination source.

### SUMMARY OF THE INVENTION

It is an object of the present disclosure to advance the art of infrared signal detection for applications using optically-chargeable phosphors. With this object in mind, an aspect of the present disclosure provides an apparatus comprising:
a) a transducer comprising a storage phosphor that is chargeable to emit light of a first wavelength in response to an excitation light of a second wavelength from an object scene, wherein the second wavelength is longer than the first wavelength;
b) a digital light sensor disposed to accumulate energy from the emitted light of the transducer and to generate a signal according to the accumulated energy;
c) a charging illumination source that is configured to direct a pulsed charging illumination of a third wavelength, shorter than the first wavelength, to the storage phosphor; and
d) a control logic processor that is in signal communication with the digital light sensor and the charging illumination source and that controls synchronization of the timing of pulsed charging illumination and energy acquisition and readout of the digital light sensor.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

For a fuller understanding of the nature and objects of the invention, reference should be made to the following detailed description, taken in connection with the accompanying drawings, in which:

FIG. 1A shows a schematic of a digital infrared detection apparatus according to an embodiment of the present disclosure wherein the digital light sensor is gated directly;

FIG. 1B shows a schematic of a digital infrared detection apparatus according to another embodiment of the present disclosure wherein the digital light sensor is gated indirectly;

FIG. 2A shows a schematic of a digital infrared detection apparatus according to still another embodiment of the present disclosure that includes an optical filter, discrete from the phosphor layer, for blocking non-infrared light;

FIG. 2B shows a schematic of a digital infrared detection apparatus according to still another embodiment of the present disclosure that includes an optical filter, integrated with the phosphor layer, for blocking non-infrared light;

FIG. 2C shows a schematic of a digital infrared detection apparatus according to still another embodiment of the present disclosure that includes a wavelength band selector for extended range detection shown configured for infrared detection;

FIG. 2D shows a schematic of a digital infrared detection apparatus according to still another embodiment of the present disclosure that includes a wavelength band selector for extended range detection shown configured for non-infrared detection;

FIG. 3A shows a schematic of a digital infrared detection apparatus according to still another embodiment of the present disclosure that includes a dichroic cold mirror for reflecting optical charging illumination towards the phosphor layer while transmitting the emitted light from the phosphor layer towards the digital light sensor;

FIG. 3B shows a schematic of a digital infrared detection apparatus according to still another embodiment of the present disclosure that includes a dichroic cold mirror for reflecting optical charging illumination towards the phosphor layer while transmitting the infrared light pattern towards the phosphor layer;

FIG. 3C shows a schematic of a digital infrared detection apparatus according to still another embodiment of the present disclosure that includes a dichroic hot mirror for transmitting optical charging illumination towards the phosphor layer while reflecting the emitted light from the phosphor layer towards the digital light sensor;

FIG. 3D shows a schematic of a digital infrared detection apparatus according to still another embodiment of the present disclosure that includes a dichroic hot mirror for transmitting optical charging illumination towards the phosphor layer while reflecting the infrared light pattern towards the phosphor layer;

FIG. 4 shows a schematic of a digital infrared detection apparatus according to still another embodiment of the present disclosure wherein the phosphor layer is directly coated over the digital light sensor;

FIG. 5 shows a schematic of a digital infrared detection apparatus according to still another embodiment of the present disclosure that includes an optical filter for blocking non-infrared light wherein the phosphor layer is directly coated over the digital light sensor;

FIG. 6A shows a schematic of a digital infrared detection apparatus according to still another embodiment of the present disclosure that includes a temperature control device for controlling the temperature of the phosphor layer;

FIG. 6B shows a schematic of a digital infrared detection apparatus according to still another embodiment of the present disclosure that includes a temperature control device for controlling the temperature of both the phosphor layer and the digital light sensor wherein the phosphor layer is directly coated over the sensor;

FIG. 7 shows a schematic of a digital infrared detection apparatus according to still another embodiment of the present disclosure whereby the phosphor layer is an external component of the apparatus;

FIG. 8 shows a timing diagram according to a method of the present disclosure for image capture; and

FIG. 9 shows a timing diagram according to a method of the present disclosure for video capture.

### DETAILED DESCRIPTION OF THE INVENTION

The invention has been described in detail with particular reference to certain preferred embodiments thereof, but it will be understood that variations and modifications can be effected within the spirit and scope of the invention. The following is a detailed description of the preferred embodiments of the invention, reference being made to the drawings in which the same reference numerals identify the same elements of structure in each of the several figures.

Figures shown and described herein are provided in order to illustrate key principles of operation and component relationships along their respective optical paths according to the present disclosure and are not drawn with intent to show actual size or scale. Some exaggeration may be necessary in order to emphasize basic structural relationships or principles of operation. Some conventional components that would be needed for implementation of the described embodiments, such as various types of optical mounts, for example, are not shown in the drawings in order to simplify description of the invention itself. In the drawings and text that follow, like components are designated with like reference numerals, and similar descriptions concerning components and arrangement or interaction of components already described are omitted. Where they are used, the terms “first”, “second”, and so on, do not denote any ordinal or priority relation, but are simply used to more clearly distinguish one element from another.

In the context of the present disclosure, an optically-chargeable phosphor is the type of storage phosphor described previously in the background section that is charged with light energy from a higher energy (shorter wavelength) charging light source, in order to allow subsequent emission at lower energy (longer wavelength) light levels, upon receiving light energy from an excitation light source that is also at lower energy than the charging light source.

In the context of the present disclosure, the term “optics” is used generally to refer to lenses and other refractive, diffractive, and reflective components or apertures used for shaping and orienting a light beam. An individual component of this type is termed an optic.

In the context of the present disclosure, the general terms “wavelength” and “wavelength band” may be used equivalently to refer to light wavelengths within the specified spectral range.

Applicants have recognized a need for an apparatus for digital infrared detection based on an optically-chargeable phosphor layer and that provides an effective countermeasure against the discharging of the optically-chargeable phosphor layer.

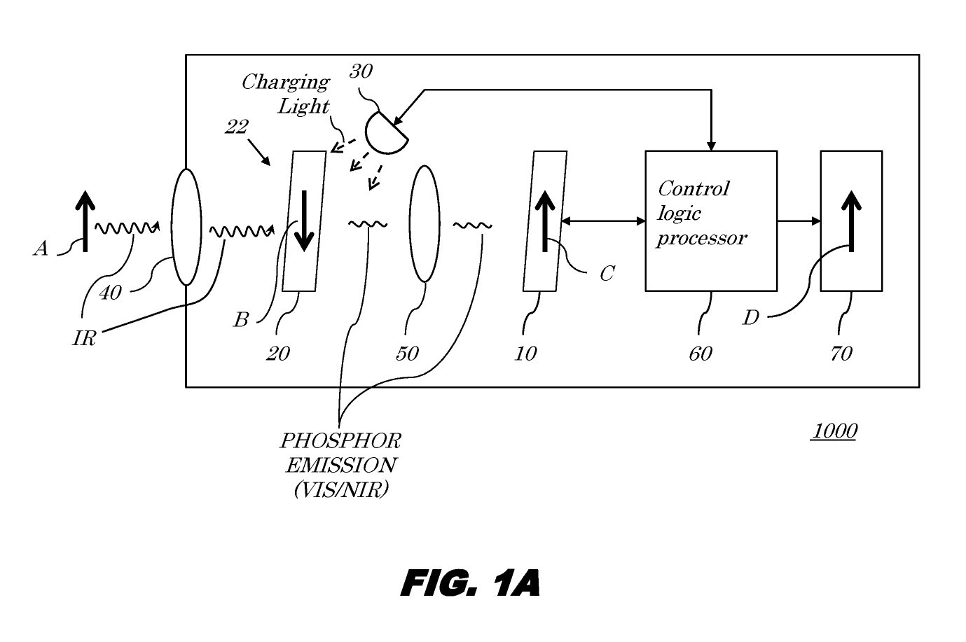

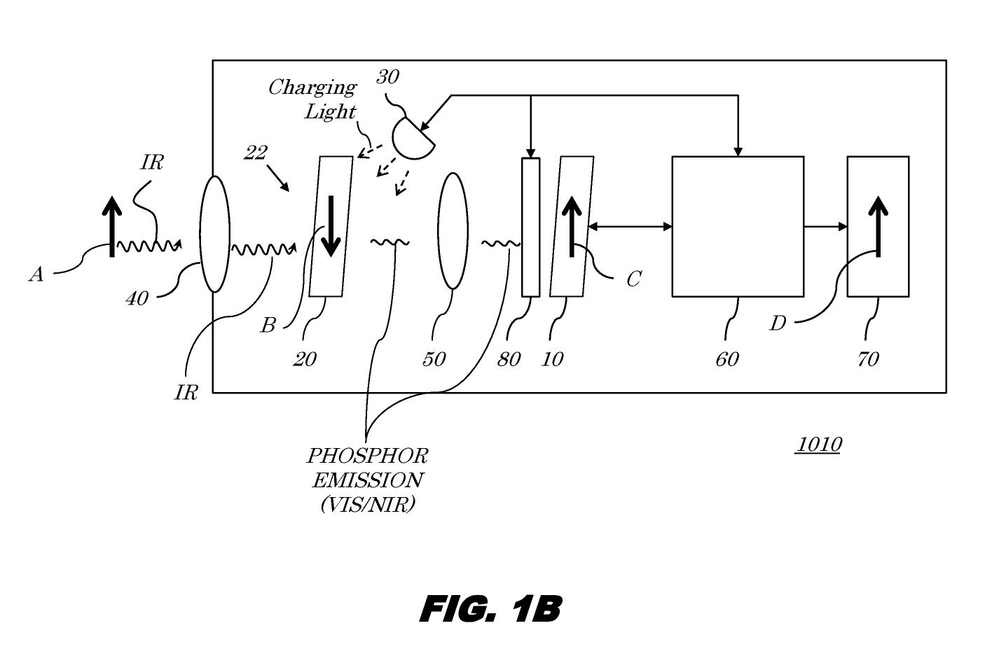

Referring to FIG. 1A, an overall design of an embodiment of an apparatus of the present disclosure has a digital light sensor 10, for example an interline-transfer charge-coupled device sensor, a frame-transfer charge-coupled device (CCD) sensor, a full-frame charge-coupled device sensor, or a complementary metal-oxide-semiconductor (CMOS) sensor. A transducer 22 has an optically-chargeable phosphor layer 20 for generating, in response to incident light of infrared wavelengths outside the sensitivity range of light sensor 10, visible or NIR light energy that lies within the sensitivity range of digital light sensor 10. In various embodiments, the emitted light is shorter in wavelength than the incident excitation light. According to an embodiment of the present disclosure, emitted light from transducer 22 is in the range from 400 to 1000 nm and the incident excitation light from the object scene is longer than 1000 nm. A pulsed charging illumination source 30 is provided for repetitively recharging phosphor layer 20 in synchronization with image capture timing. The goal of gating is to synchronize charging and detection so that sensor 10 detects only the desired image content that results from incident infrared light from object scene A and ignores the charging energy from illumination source 30 as well as any intrinsic phosphorescence or autofluorescence energy simulated solely by the optical charging illumination and not emitted in response to the incident infrared light.

Gating synchronization, a function controlled through a control logic processor 60, operates as follows: during pulse intervals when phosphor layer 20 is being charged, image energy is not obtained by digital light sensor 10. During alternate pulse intervals when phosphor layer is not being charged, digital light sensor 10 is gated to accumulate or capture image content resulting from infrared light that is incident on phosphor layer 20. For methods that are based on integrating multiple exposures, one during each pulse interval, image noise can be significantly reduced, since there is only a single readout of the light sensor 10, rather than multiple readout events.

The gating of digital light sensor 10 may be carried out in a number of ways familiar to those skilled in the art. One gating approach uses direct control of the sensor, for example in the case of an interline-transfer charge coupled device (CCD), by electronically controlling the charge-drain facility on the CCD component as described by Mitchell et al. in “Measurement of nanosecond time-resolved fluorescence with a directly gated interline CCD camera”, J. Microscopy, 206, 233-238 (2002). Using sensor gating, digital light sensor 10 accumulates the photocharge generated corresponding to the visible or NIR light pattern that is present only during those intervals when pulsed illumination source 30 is not charging phosphor layer 20, and further discards the photocharge generated during those intervals when pulsed illumination source 30 is charging phosphor layer 20.

Alternatively, the gating of digital light sensor 10 may be carried out indirectly by other means external to sensor 10 and known in the art. External gating mechanisms can include, for example a mechanical shutter or chopper wheel, a movable mirror or digital micromirror device such as a digital light processor (DLP) from Texas Instruments, Dallas, Tex., a liquid crystal device, or an image intensifier such as a proximity-focused intensifier that incorporates a microchannel plate electron multiplier that can be gated by pulsing the voltage between the light-sensitive photocathode and the front face of the microchannel plate, or alternatively by switching the voltage across the microchannel. Using such an external mechanism, digital light sensor 10 accumulates the photocharge that has been generated corresponding to the visible or NIR light pattern that is present only during those intervals when pulsed illumination source 30 is not charging phosphor layer 20. When pulsed illumination source 30 is directed to phosphor layer 20 for charging, image content is not available to sensor 10. Furthermore, the gating of digital light sensor 10 may include a delay for compensating some interval of afterglow of phosphor layer 20 immediately following charging. Afterglow can occur, for example, due to intrinsic phosphorescence or autofluorescence simulated only by the optical charging illumination and not in response to incident infrared illumination. Afterglow effects can tend to diminish or contaminate the desired signal content, providing unwanted background artifacts. Delay can help to reduce effects of intrinsic phosphorescence decay.

Illumination source 30 used for charging can be any of a number of types of light source known in the art, such as a light emitting diode, laser, laser diode, or lamp, for example. Illumination source 30 may be pulsed directly, for example by an electrical circuit, or pulsed by external mechanisms, such as by a mechanical shutter or chopper. Furthermore, illumination source 30 may have any suitable physical configuration, for example a spotlight or ringlight. Illumination source 30 may include a number of illuminating elements; and may have any suitable physical arrangement and supporting optical components for charging phosphor layer 20 during a charging interval. Illumination source 30 generates light in the ultraviolet (UV) or visible light, in the wavelength range below about 700 nm. Charging illumination for a particular configuration can be dependent on the phosphor that is used.

FIG. 1A shows a schematic of a digital infrared detection apparatus 1000 according to an embodiment of the present disclosure. Scene A provides infrared (IR) light, represented by longer wavy arrows. For example, the infrared light provided by scene A may be the result of emission, reflection, transmission, scattering, or diffraction. The infrared light provided by scene A is projected onto phosphor layer 20 as a pattern B. A pattern forming optic 40 is shown for forming infrared pattern B.

In subsequent schematics of the various embodiments, the pattern forming optic 40 is shown as a single lens that simply reverses the image of scene A. More generally, any pattern forming optic as known in the art, such as monolithic or multi-element lenses, mirrors, plenoptic arrays, prisms, diffraction gratings, interferometers, and combinations thereof, may be used, and the projected infrared pattern may be the result of light conditioning by any such pattern forming optic. Furthermore, certain applications, for example beam visualization, may not require a pattern forming optic. Illumination source 30 is repetitively pulsed for repetitively recharging phosphor layer 20, using timing described in more detail subsequently.

In FIG. 1A, illumination source 30 is shown positioned to illuminate the side of phosphor layer 20 from an oblique angle, with the charging illumination incident opposite to the side on which the infrared light is incident. Alternatively, illumination source 30 may be positioned to illuminate the same side of phosphor layer 20 on which the infrared light is incident, or illumination source 30 may be positioned to simultaneously illuminate both sides of phosphor layer 20 during the charging interval.

When charged, phosphor layer 20 emits a pattern of visible or NIR light, represented by a shorter wavy sinusoidal curve, that corresponds to the pattern of infrared light that is incident upon phosphor layer 20 from object scene A. An image forming optic 50 forms an image C of the visible or NIR light emitted by phosphor layer 20, which is in the object space of image forming optic 50, onto digital light sensor 10. Digital light sensor 10 may be any digital light sensor known in the art, for example a charge-coupled device (CCD) sensor, a complementary metal-oxide-semiconductor (CMOS) sensor, or other sensor that is capable of detecting the visible or NIR light emitted from phosphor layer 20. A control logic processor 60 is in signal communication with digital light sensor 10. Control logic processor 60 triggers the image or video capture by digital light sensor 10, triggers the repetitive pulsing of illumination source 30, repetitively directly gating digital light sensor 10 in synchronization with repetitively pulsed illumination source 30 during capture, and delivers digital image or video data D to a display 70 that is in signal communication with control logic processor 60. Alternatively the image or video capture by digital light sensor 10 may be externally triggered, for example by one or more events related to scene A. Also alternatively, control logic processor 60 may be triggered by illumination source 30, for example by a direct electrical signal from illumination source 30 or by indirect detection using a photosensor (not shown). Also the digital image or video data may be saved, printed, displayed, stored, or transmitted by control logic processor 60 to an external processor or storage device.

Control logic processor 60 can be any of a number of types of logic processing devices including, for example, a microprocessor, dedicated processor, or computer system, including a networked computer device. Control logic processor 60 is programmed with instructions to control and coordinate the timing of transducer charging, signal acquisition, and readout, and to provide at least some measure of image processing for preparation and display or for transmission or storage of the acquired image data.

FIG. 1B shows a schematic of a digital infrared detection apparatus 1010 according to another embodiment of the present disclosure. Apparatus 1010 is similar to apparatus 1000 shown in FIG. 1A except that, instead of directly gating digital light sensor 10, control logic processor 60 indirectly gates digital light sensor 10 by means of an external synchronizer such as an indirect gating device 80, for example a mechanical shutter, a chopper wheel, a movable mirror, a digital micromirror device, a liquid crystal device, or an image intensifier.

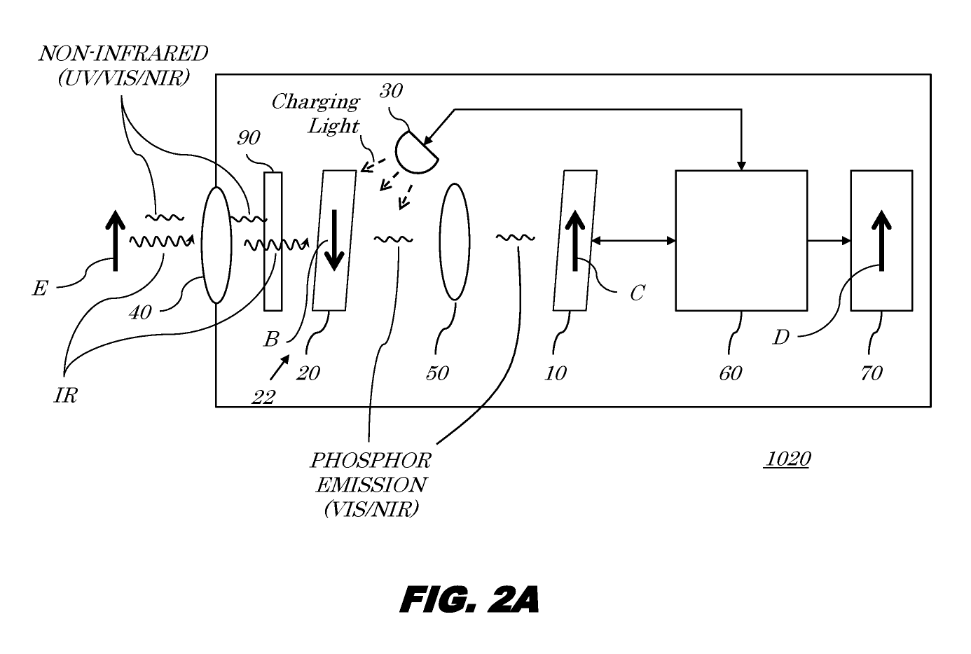

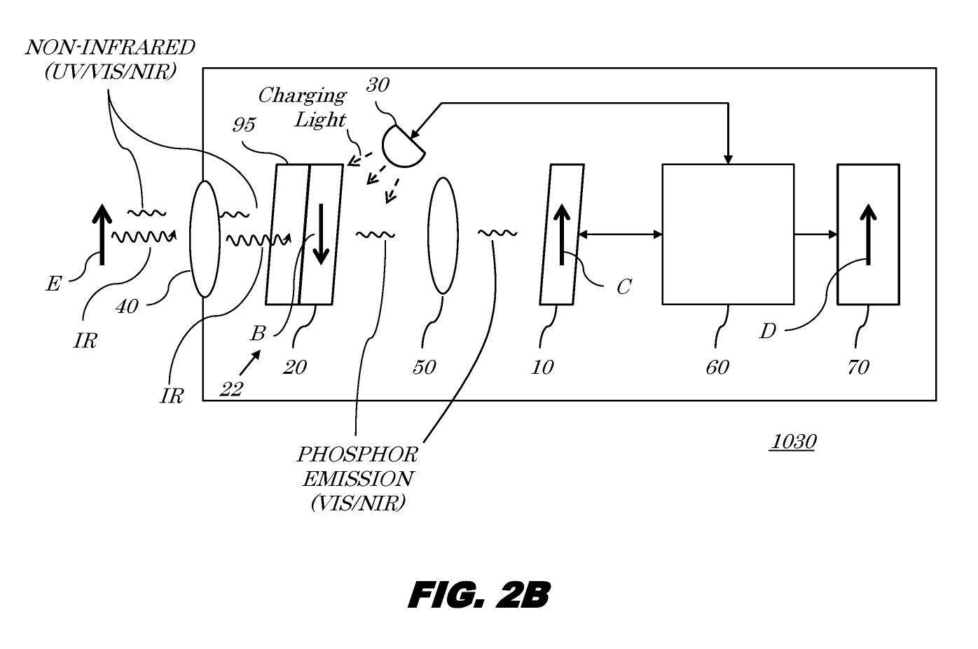

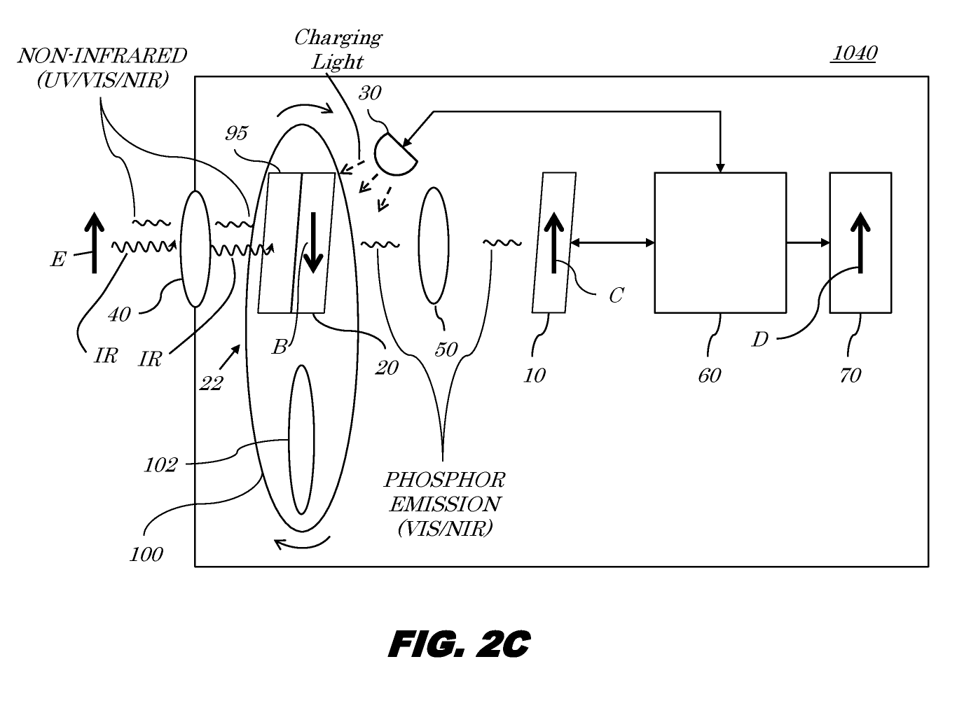

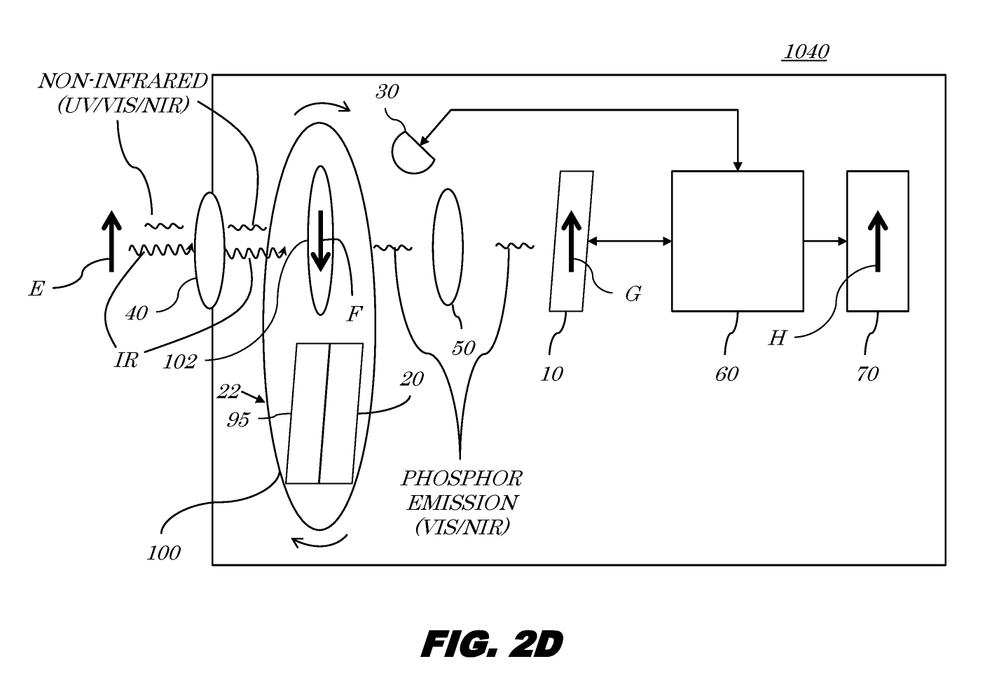

FIG. 2A shows a schematic of a digital infrared detection apparatus 1020 according to another embodiment of the present disclosure. Scene E provides infrared (IR) light. Scene E also provides non-infrared light within the sensitivity range of digital light sensor 10, represented by the shorter wavy sinusoidal curve, such as UV, visible, or NIR light, for example. If this light were allowed to reach, and fall within the sensitivity range of, digital light sensor 10, the non-infrared light could add unwanted background, and hence contaminate, the desired infrared image signal. Furthermore, if the non-infrared light were allowed to reach phosphor layer 20, portions of the non-infrared light could charge phosphor layer 20 in an undesirable way. For example, the light could charge phosphor layer 20 in a non-uniform manner that may degrade the image quality of the infrared image. Apparatus 1020 is similar to apparatus 1000 shown in FIG. 1A except that an optical filter 90, discrete from phosphor layer 20, is included for substantially transmitting infrared light and substantially blocking non-infrared light. FIG. 2A shows filter 90 substantially reflecting the non-infrared light. Alternatively, filter 90 may substantially absorb, or partially absorb and partially reflect, the non-infrared light. FIG. 2A shows filter 90 positioned immediately in front of phosphor layer 20 so as to block the non-infrared light from being incident upon phosphor layer 20 and, because phosphor layer 20 may be at least partially transparent to the non-infrared light, from also being incident upon digital light sensor 10. Alternatively, filter 90 may be positioned anywhere between scene E and phosphor layer 20, or furthermore, anywhere in front of digital light sensor 10.

FIG. 2B shows a schematic of a digital infrared detection apparatus 1030 according to another embodiment of the present disclosure. Apparatus 1030 is similar to apparatus 1020 shown in FIG. 2A with optical filter 95 additionally integrated with phosphor layer 20. For example, phosphor layer 20 can be coated onto one side of a transparent substrate, with filter 95 coated onto the other side.

Alternatively, phosphor layer 20 and filter 95 may each be coated on individual substrates, and the two substrates cemented together. Integration of filter 95 with phosphor layer 20 as part of transducer 22 may provide a compact and efficient use of space.

FIGS. 2C and 2D show schematics of a digital infrared detection apparatus 1040 according to another embodiment of the present disclosure. Apparatus 1040 is similar to apparatus 1030 shown in FIG. 2B with phosphor layer 20, with integrated filter 95, mounted in a wavelength band selector 100. The wavelength band selector may have the form of a rotatable wheel that includes a zone for infrared detection, in which phosphor layer 20 is mounted, and at least one additional zone for non-infrared detection, for example an empty aperture 102, as shown in FIGS. 2C and 2D. Alternatively wavelength band selector 100 may have the form of a translatable panel, or generally any mechanism capable of exchanging between a first configuration with phosphor layer 20 inserted into the detection optical path for infrared detection and a second configuration where the detection optical path is capable of non-infrared detection, such as visible light sensing for example. Wavelength band selector 100 may be controlled by control logic processor 60, or alternatively may be independently controlled.

FIG. 2C shows apparatus 1040 configured for infrared detection with pattern forming optic 40 forming infrared pattern B onto phosphor layer 20, which is in the object space of image forming optic 50 so that image C of the emission of phosphor layer 20 is formed and delivered as digital image or video data D. FIG. 2D shows apparatus 1040 configured for non-infrared detection with pattern forming optic 40 forming non-infrared pattern F into aperture 102, which is also in the object space of image forming optic 50, so that image G of non-infrared pattern F is formed and delivered as digital image or video data H.

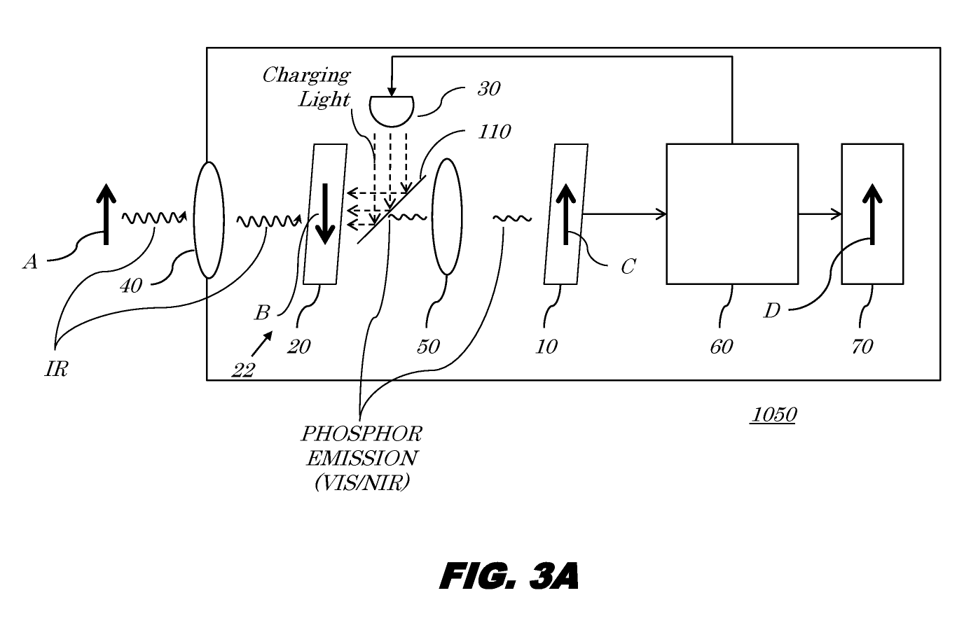

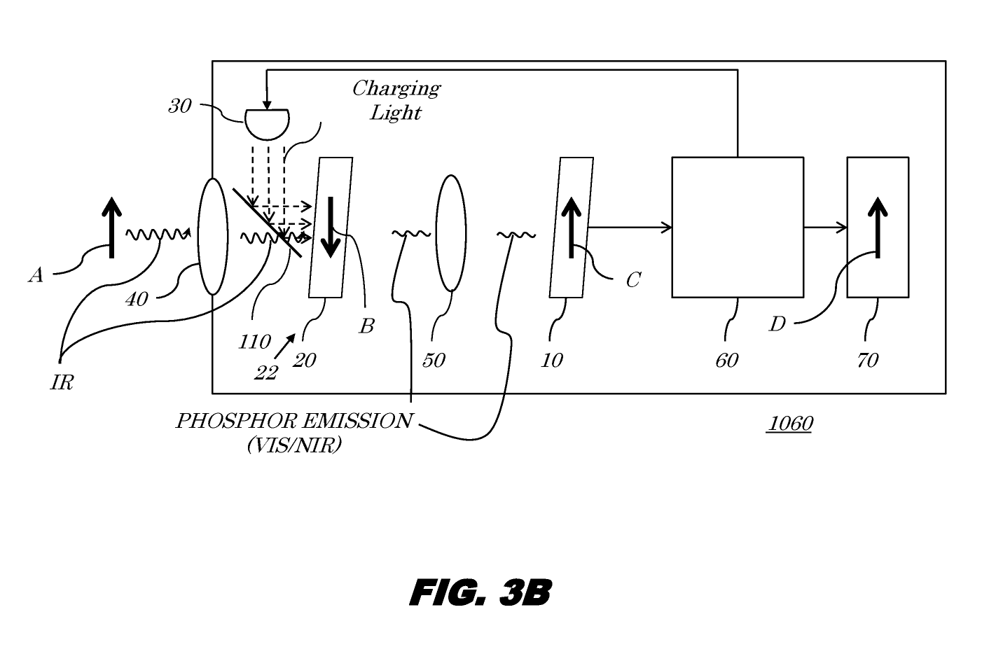

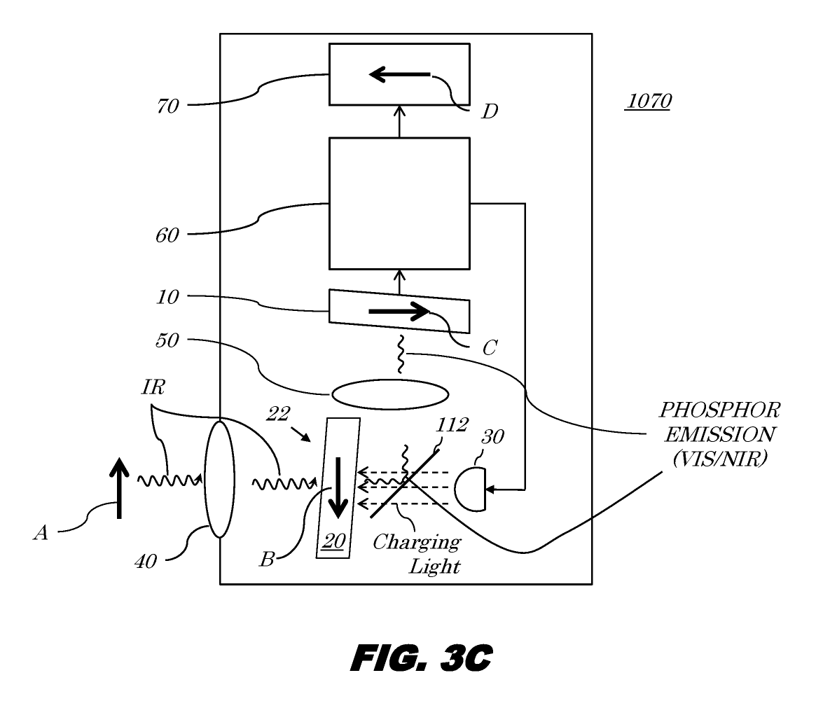

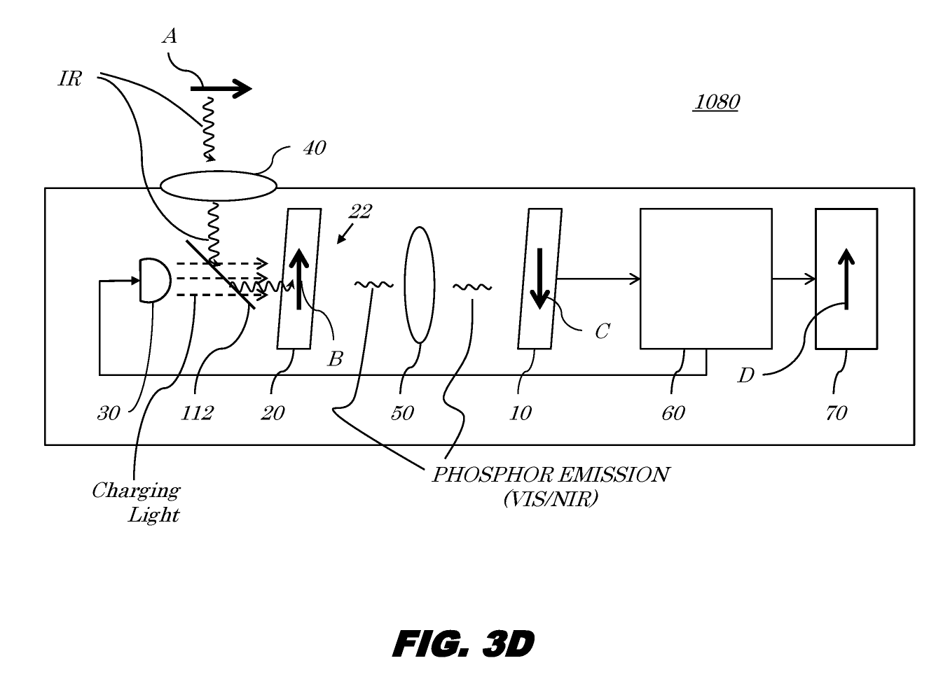

FIGS. 3A, 3B, 3C, and 3D show schematics of digital infrared detection apparatus 1050, 1060, 1070, and 1080, respectively, that make use of various dichroic mirrors, also known as cold mirrors and hot mirrors, for evenly directing charging illumination towards phosphor layer 20 according to further embodiments of the present disclosure.

FIG. 3A shows a schematic of apparatus 1050 which is similar to apparatus 1000 shown in FIG. 1A except that a dichroic cold mirror 110, that transmits infrared light and reflects light having wavelengths shorter than infrared, is included between phosphor layer 20 and image forming optic 50. Illumination source 30 in this configuration, through mirror 110, directs charging illumination at a normal to phosphor layer 20. Charging illumination is from the side of phosphor layer 20 that faces towards digital light sensor 10.

FIG. 3B shows a schematic of apparatus 1060 which is similar to apparatus 1050 shown in FIG. 3A except that dichroic cold mirror 110 is spatially disposed between pattern forming optic 40 and phosphor layer 20. The charging illumination from illumination source 30 reflects from dichroic cold mirror 110 to illuminate phosphor layer 20 at a normal, along the side opposite digital light sensor 10.

FIG. 3C shows a schematic of apparatus 1070 which is similar to apparatus 1050 shown in FIG. 3A but has a different mirror configuration for charging illumination. Instead of a dichroic cold mirror 110, a dichroic hot mirror 112 that reflects infrared light and transmits light having wavelengths shorter than infrared, is used. Mirror 112 transmits the charging illumination from illumination source 30 to illuminate the rear side of phosphor layer 20 at a normal.

FIG. 3D shows a schematic of apparatus 1080 which is similar to apparatus 1070 shown in FIG. 3C. In apparatus 1080, however, dichroic hot mirror 112 is disposed so that the charging illumination from illumination source 30 normally illuminates the front side of phosphor layer 20.

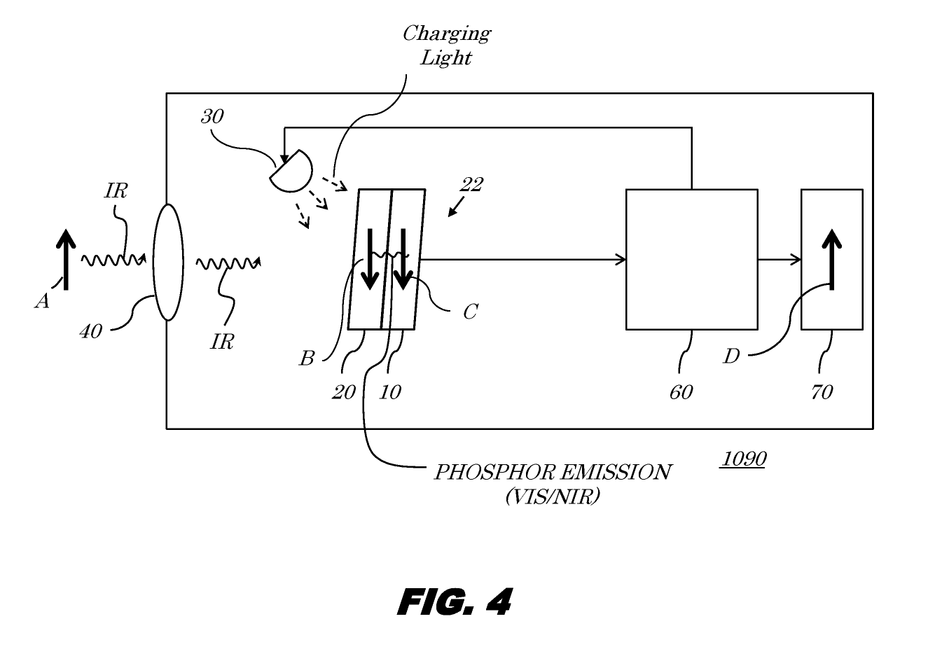

FIG. 4 shows a schematic of digital infrared detection apparatus 1090 according to another embodiment of the present disclosure. Apparatus 1090 is similar to apparatus 1000 shown in FIG. 1A except that phosphor layer 20 of transducer 22 is directly coated over digital light sensor 10. Visible or NIR light emitted by phosphor layer 20 is directly incident and spatially resolved by digital light sensor 10 without need of an image forming optic. Illumination source 30 is shown to illuminate the front side of phosphor layer 20.

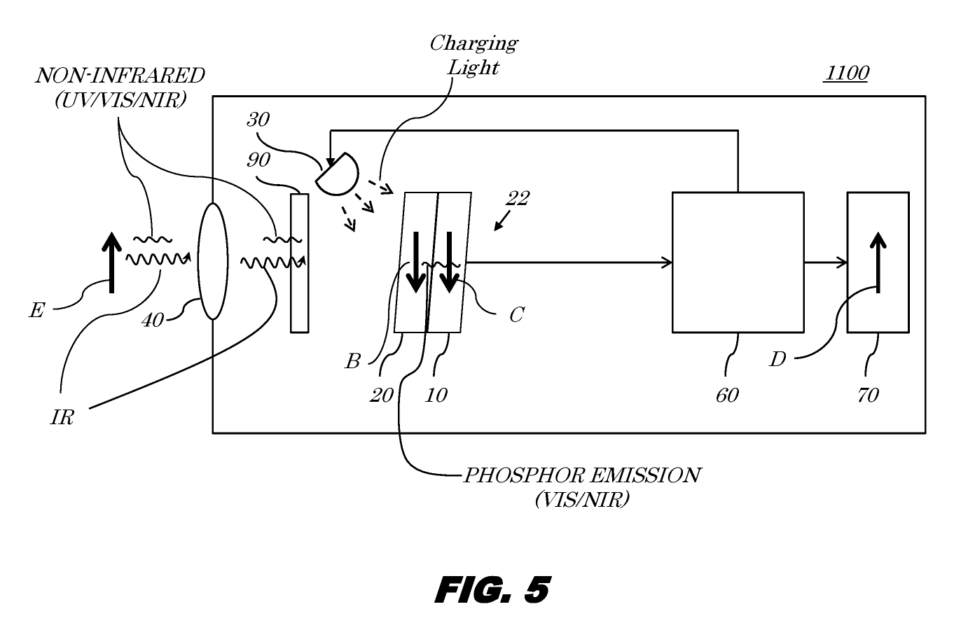

FIG. 5 shows a schematic of a digital infrared detection apparatus 1100 according to another embodiment of the present disclosure. Scene E provides both infrared (IR) light and non-infrared light. Digital light sensor 10 is sensitive to the non-IR light, for example, UV, visible, or NIR light. If this non-IR light were allowed to reach digital light sensor 10, it could add unwanted background artifacts, and hence contaminate, the desired infrared image. Furthermore, if the non-IR light were allowed to reach phosphor layer 20, the non-IR light could itself charge phosphor layer 20 in an undesirable manner, for example, with a non-uniform energy distribution. This unwanted effect could degrade the image quality of the infrared image. Apparatus 1100 is similar to apparatus 1090 shown in FIG. 4 with the addition of optical filter 90, discrete from phosphor layer 20. Optical filter 90 substantially transmits infrared light and substantially blocks non-infrared light. FIG. 5 shows filter 90 substantially reflecting the non-infrared light. Alternatively, filter 90 may substantially absorb, or partially absorb and partially reflect, the non-infrared light. FIG. 5 shows filter 90 positioned immediately in front of phosphor layer 20 so as to block non-IR incidence upon phosphor layer 20 and, because phosphor layer 20 may be at least partially transparent to the non-infrared light, also upon digital light sensor 10. Alternatively, filter 90 may be positioned anywhere between scene E and phosphor layer 20, including in physical contact with phosphor layer 20.

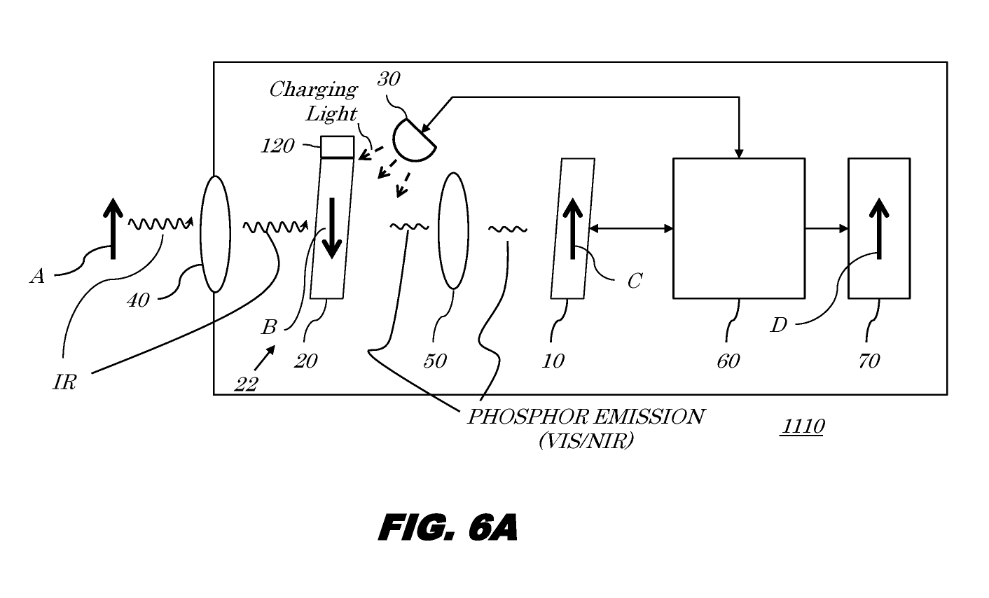

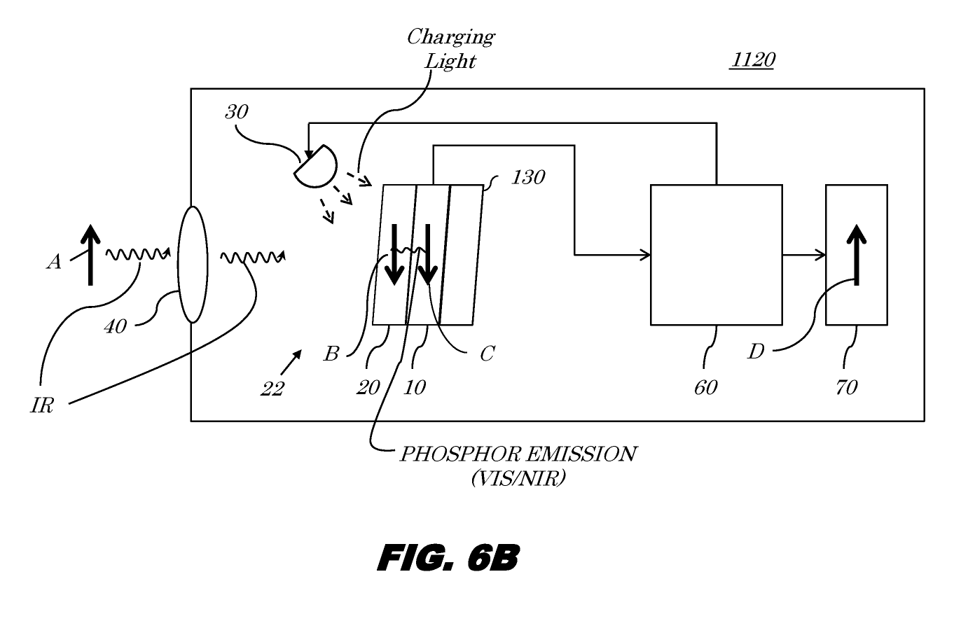

FIG. 6A shows a schematic of a digital infrared detection apparatus 1110 according to another embodiment of the present disclosure. Apparatus 1110 is similar to apparatus 1000 shown in FIG. 1A, with phosphor layer 20 of transducer 22 thermally coupled to a temperature control device 120 for controlling the temperature of phosphor layer 20. Temperature control device 120 may include a cooling mechanism, for example a thermoelectric cooler, for cooling phosphor layer 20 to reduce thermal energy. Unwanted thermal energy could otherwise cause spontaneous emission and resulting unwanted background artifacts detected by digital light sensor 10, due to trapped electrons escaping from their traps. Also, temperature control device 120 may include a heating mechanism, for example a resistive heater. A heating mechanism can temporarily heat phosphor layer 20 during periods when digital light sensor 10 is insensitive to, or gated to not detect, light. Added heat can help to accelerate afterglow or the escape of electrons from shallow traps to help reduce unwanted background artifacts that would otherwise contaminate the signal detected by digital light sensor 10 during image capture. Generally, temperature control device 120 could include both cooling and heating mechanisms for optimizing the thermal processing of phosphor layer 20 to minimize the unwanted background that would otherwise contaminate the signal detected by digital light sensor 10 during image capture.

FIG. 6B shows a schematic of a digital infrared detection apparatus 1120 according to another embodiment of the present disclosure. Apparatus 1120 is similar to apparatus 1090 shown in FIG. 4 with both phosphor layer 20 and digital light sensor 10 thermally coupled to temperature control device 130. This arrangement helps to control the temperature of both phosphor layer 20 and digital light sensor 10. Temperature control device 130 may include a cooling mechanism, for example a thermoelectric cooler, for cooling phosphor layer 20 to reduce thermal energy. Excessive thermal energy could otherwise cause spontaneous emission, and the resulting unwanted background detected by digital light sensor 10, due to trapped electrons escaping from their traps. Cooling of digital light sensor 10 can also help to reduce dark current inherent to digital light sensor 10. Also, temperature control device 130 may include a heating mechanism, for example a resistive heater. A heating mechanism can help for temporarily heating phosphor layer 20 during periods when digital light sensor 10 is insensitive to light, or gated to block light detection. This can help to accelerate afterglow or the escape of electrons from shallow traps for reducing unwanted background noise that would otherwise contaminate the signal detected by digital light sensor 10 during image capture. Heat can also help for temporarily accelerating the depletion of residual image that may accumulate in digital light sensor 10. Generally, temperature control device 130 could include both cooling and heating mechanisms for optimizing the thermal processing of phosphor layer 20. This arrangement can help to reduce unwanted background noise that would otherwise contaminate the signal detected by digital light sensor 10 during image capture, as well as to improve the performance of digital light sensor 10 itself.

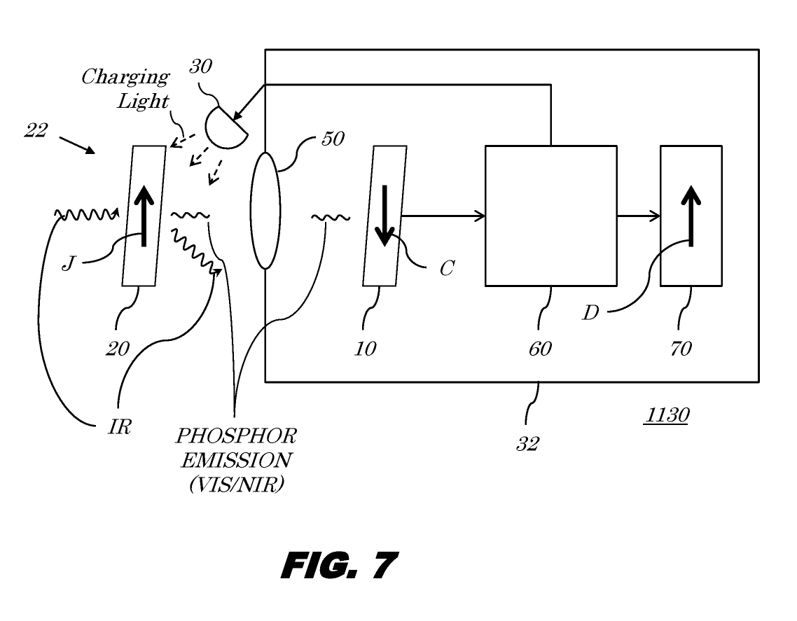

FIG. 7 shows a schematic of a digital infrared detection apparatus 1130 according to another embodiment of the present disclosure. Apparatus 1130 is similar to apparatus 1000 shown in FIG. 1A and is shown in a housing 32, with transducer 22 and its phosphor layer 20 outside the housing 32 as an external component of the apparatus. As such, infrared light may be incident upon phosphor layer 20 from any direction in order to form an infrared pattern J.

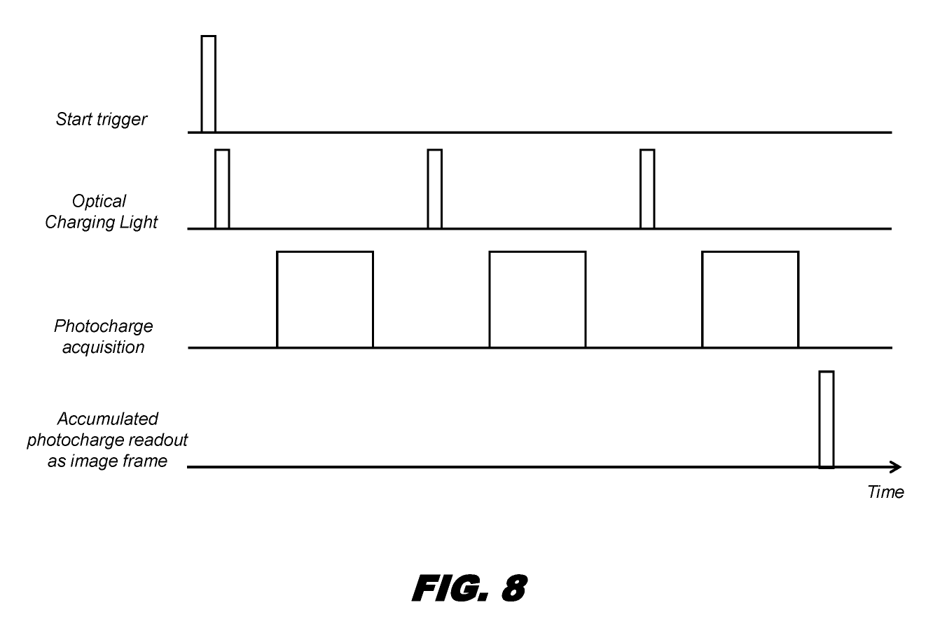

FIG. 8 shows a timing synchronization diagram coordinated and controlled by control logic processor 60 (FIGS. 1A-7) for still image capture according to a method of the present disclosure. A “Start trigger” signal from control logic processor 60 to digital light sensor 10 triggers the start of an image frame capture. An “Optical Charging Light” signal defines the timing of a momentary charging period for energizing repetitively pulsed illumination source 30 for recharging phosphor layer 20. Once charging is suspended, a “Photocharge acquisition” signal defines each photocharge acquisition period during which digital light sensor 10 acquires accumulated photocharge from the visible or NIR pattern provided by phosphor layer 20 of transducer 22. As the relative timing synchronization shows, optical charging and photocharge acquisition cannot happen at the same time. A gating mechanism, as described previously, is used to control this synchronization between transducer charging and reading the digital light sensor “photocharge” signal resulting from external field excitation of the transducer by light from the object scene. Digital light sensor 10 is repetitively gated with alternating timing with respect to repetitively pulsed illumination source 30, so that digital light sensor 10 accumulates image data from the object scene only during intervals when it is not being charged. The number of time periods allowed for a complete image acquisition can be programmable or triggered by a stop trigger signal. An “Accumulated photocharge readout as image frame” signal shows readout timing for the accumulated photocharge and delivery to control logic processor 60 at completion of image capture.

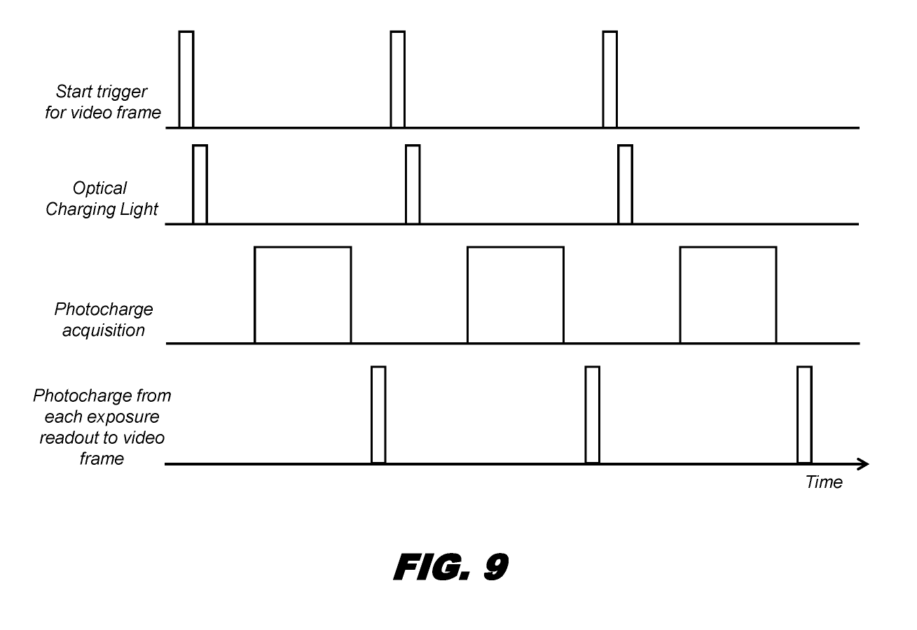

Synchronization is similarly implemented for video capture. FIG. 9 shows a timing diagram according to a method of the present disclosure for video capture. Control logic processor 60 generates a “Start trigger for video frame” signal to trigger the start of capture of each video frame from digital light sensor 10. An “Optical Charging Light” signal defines the timing of a momentary charging period for energizing repetitively pulsed illumination source 30 for recharging phosphor layer 20. After suspending the charging period, a “Photocharge acquisition” signal then defines each photocharge acquisition period during which digital light sensor 10 acquires photocharge corresponding to the visible or NIR light pattern provided from phosphor layer 20. As was described for the timing synchronization diagram of FIG. 8, optical charging of the transducer and photocharge acquisition from the transducer cannot happen at the same time. A gating mechanism is used to control synchronization between charging the transducer and obtaining the transducer signal resulting from external field excitation. Digital light sensor 10 is repetitively gated with alternating timing with respect to repetitively pulsed illumination source 30, so that digital light sensor 10 accumulates image data from the object scene only during intervals when it is not being charged. The number of time periods allowed for a complete image capture may be programmable or triggered by a stop trigger signal. A “Photocharge from each exposure readout to video frame” signal shows readout timing for each exposure and delivery to control logic processor 60 for each video frame.

It is therefore clear that an object of this disclosure is to advance the art of infrared imaging by providing an apparatus for digital infrared imaging, comprising a gateable digital light sensor, an optically-chargeable transducer with a phosphor layer for transducing an infrared light pattern incident upon the phosphor layer into a visible or NIR light pattern that is imageable by the digital light sensor, and a repetitively pulsed light source for repetitively recharging the phosphor layer, wherein the digital light sensor is repetitively gated opposite to the repetitively pulsed light source during image or video capture.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention.

What is claimed is:

1. An apparatus comprising:
a) a transducer comprising a storage phosphor that is chargeable to emit light of a first wavelength in response to an excitation light of a second wavelength from an object scene, wherein the second wavelength is longer than the first wavelength;
b) a digital light sensor disposed to accumulate energy from the emitted light of the transducer and to generate a signal according to the accumulated energy;
c) a charging illumination source that is configured to direct a pulsed charging illumination of a third wavelength, shorter than the first wavelength, to the storage phosphor; and
d) a control logic processor that is in signal communication with the digital light sensor and the charging illumination source and that controls synchronization of the timing of pulsed charging illumination and energy acquisition and readout of the digital light sensor.

2. The apparatus of claim 1 wherein the first wavelength has the range from 400 to 1000 nm, wherein the second wavelength is longer than 1000 nm, and wherein the third wavelength is shorter than 700 nm.

3. The apparatus of claim 1 further comprising an external gating device in signal communication with the control logic processor for synchronization timing.

4. The apparatus of claim 1 further comprising an optical filter disposed to block light of the first wavelength from the object scene.

5. The apparatus of claim 4 wherein the optical filter is part of the transducer.

6. The apparatus of claim 1 further comprising a wavelength band selector for selectively removing the transducer from between the object scene and the digital light sensor.

7. The apparatus of claim 1 further comprising a dichroic mirror that is disposed to reflect the charging illumination of the third wavelength toward the storage phosphor and to transmit emitted light of the first wavelength.

8. The apparatus of claim 1 further comprising a dichroic mirror that is disposed to transmit the charging illumination of the third wavelength toward the storage phosphor and to reflect emitted light of the first wavelength toward the digital light sensor.

9. The apparatus of claim 1 further comprising a dichroic mirror that is disposed to transmit the charging illumination of the third wavelength toward the storage phosphor and to reflect light of the second wavelength toward the digital light sensor.

10. The apparatus of claim 1 wherein the phosphor layer is coated onto the digital light sensor.

11. The apparatus of claim 1 further comprising a temperature control device coupled to the transducer.

12. The apparatus of claim 1 further comprising a temperature control device coupled to the transducer and to the digital light sensor.

13. The apparatus of claim 11 wherein the temperature control device is a thermoelectric cooler.

14. The apparatus of claim 1 wherein the digital light sensor and control logic processor are within a housing and wherein the transducer is external to the housing.

15. The apparatus of claim 1 wherein the digital light sensor is a charge-coupled device.

16. An apparatus for infrared imaging comprising:
a) a transducer comprising a storage phosphor that is chargeable to emit light of a first wavelength in response to an excitation light of a second wavelength from an object scene, wherein the second wavelength is longer than the first wavelength;
b) a pattern forming optic that directs light from the object scene to the transducer;
c) an image forming optic that directs emitted light from the transducer to a digital light sensor;
d) the digital light sensor disposed to accumulate energy from the emitted light of the transducer and to generate a signal according to the accumulated energy;
e) a charging illumination source that is configured to direct a pulsed charging illumination of a third wavelength, shorter than the first wavelength, to the storage phosphor;
f) a control logic processor that is in signal communication with the digital light sensor to obtain the generated signal and with the charging illumination source, wherein the control logic processor is programmed with instructions to control synchronization of the timing of pulsed charging illumination and energy acquisition and readout from the digital light sensor; and
g) a display in signal communication with the control logic processor for display of the acquired emitted light content from the digital light sensor.

17. A method for infrared imaging comprising:
a) forming a transducer comprising a storage phosphor that is chargeable to emit light of a first wavelength in response to an excitation light of a second wavelength from an object scene, wherein the second wavelength is longer than the first wavelength;
b) disposing a digital light sensor in the path of the emitted light of the transducer;
c) repeating a process of:
(i) gating the digital light sensor, during a charging period, to momentarily suspend energy accumulation;
(ii) during the charging period, directing a pulsed charging illumination to the storage phosphor, wherein the charging illumination is of a third wavelength, shorter than the first wavelength; and
(iii) suspending the charging period and accumulating energy from the emitted light of the transducer, during a photocharge acquisition period; and
d) obtaining a readout signal generated by the digital light sensor according to the accumulated energy.

18. The method of claim 17 further comprising displaying an image formed according to the accumulated energy from the digital light sensor.
